(19) United States
(12) Patent Application Publication
(10) Pub. No.: US 2004/0078694 A1
(43) Pub. Date: Apr. 22, 2004

(54) Event detection and message transmission apparatus, systems, and methods

(76) Inventors: Samuel M. Lester, Boise, ID (US); Jimmy Sfaelos, Eagle, ID (US)

Correspondence Address: HEWLETT-PACKARD COMPANY, Intellectual Property Administration, P.O. Box 272400, Fort Collins, CO, 80527-2400, US

(21) Appl. No.: 10/274,737

(22) Filed: Oct. 21, 2002

(51) Int. Cl. H04B 1/74

(52) U.S. Cl. 714/39

(57) ABSTRACT

An apparatus and system include an event detection module for location within a resource to detect a plurality of named events associated with the resource including a selected event; a message transmission module to transmit a message to an address, wherein the message includes the address, the selected event, and a plurality of status conditions associated with the resource, and a storage module to store the message. An article includes instructions causing a machine to execute a method including storing an address associated with a selected event in a nonvolatile memory included in a resource, wherein the selected event is associated with a condition of the resource; detecting the selected event; transmitting a message to the address at a time, wherein the message includes the address, the selected event, and the time; and storing the message in the nonvolatile memory.

### TECHNICAL FIELD

Embodiments of the invention relate generally to apparatus, systems, and methods for event detection and message transmission.

### BACKGROUND INFORMATION

In a world increasingly influenced by the existence of networks, managing the operation of various interconnected resources has never been more important. Output devices, including printers, fax machines, and tape drives are among such resources.

Typically, several different entities are concerned with the performance of various resources connected to a network, as well as specific events associated with those resources that occur during routine operations. For example, in the case of a printer, a Printer Supplies Purchaser may wish to know when the toner is low on a particular printer so that an additional cartridge can be ordered before the toner runs out completely. Similarly, a Maintenance Technician might like to know that a printer has had ten paper jams occur in the last three hours, indicating a possible problem with the type of paper loaded into the printer.

To address this need, some printers have been designed to send messages, including consumable usage data, to a selected email address. However, several conditions can occur which result in a failure to notify the desired party, such as a Printer Administrator. For example, the message can be sent to an improperly selected (i.e., incorrect or inoperative) address, or the resource can suffer an internal network connectivity hardware/software failure. There can even be external network problems that exist at the time the message is sent (e.g., mailbox full at the destination address). Unfortunately, each of these causes all have the same result—which is non-delivery of the message, and currently available printers do not provide a mechanism for determining the cause of the problem. In addition, even when emails have been successfully sent/received, Printer Administrators may want to have individual printers store all such messages (i.e., “alerts”) so that records of emails sent (e.g., timed stamped, and ordered) can be located at the printer, and/or at some type of mass storage associated with the printer.

### BRIEF DESCRIPTION OF THE DRAWINGS

FIG. 1 is a block diagram of an apparatus, an article including a machine-accessible medium, and a system according to various embodiments of the invention;

FIG. 2 illustrates a group of messages sent and stored by a printer resource according to an embodiment of the invention; and

FIG. 3 is a flow diagram illustrating a method according to an embodiment of the invention.

### DETAILED DESCRIPTION

In the following detailed description of various embodiments of the invention, reference is made to the accompanying drawings which form a part hereof, and in which are shown by way of illustration, and not of limitation, specific embodiments in which the invention can be practiced. The embodiments illustrated are described in sufficient detail to enable those skilled in the art to practice the teachings disclosed herein. Other embodiments can be utilized and derived therefrom, such that structural and logical substitutions and changes can be made without departing from the scope of this disclosure. The following detailed description, therefore, is not to be taken in a limiting sense, and the scope of various embodiments of the invention is defined only by the appended claims, along with the full range of equivalents to which such claims are entitled.

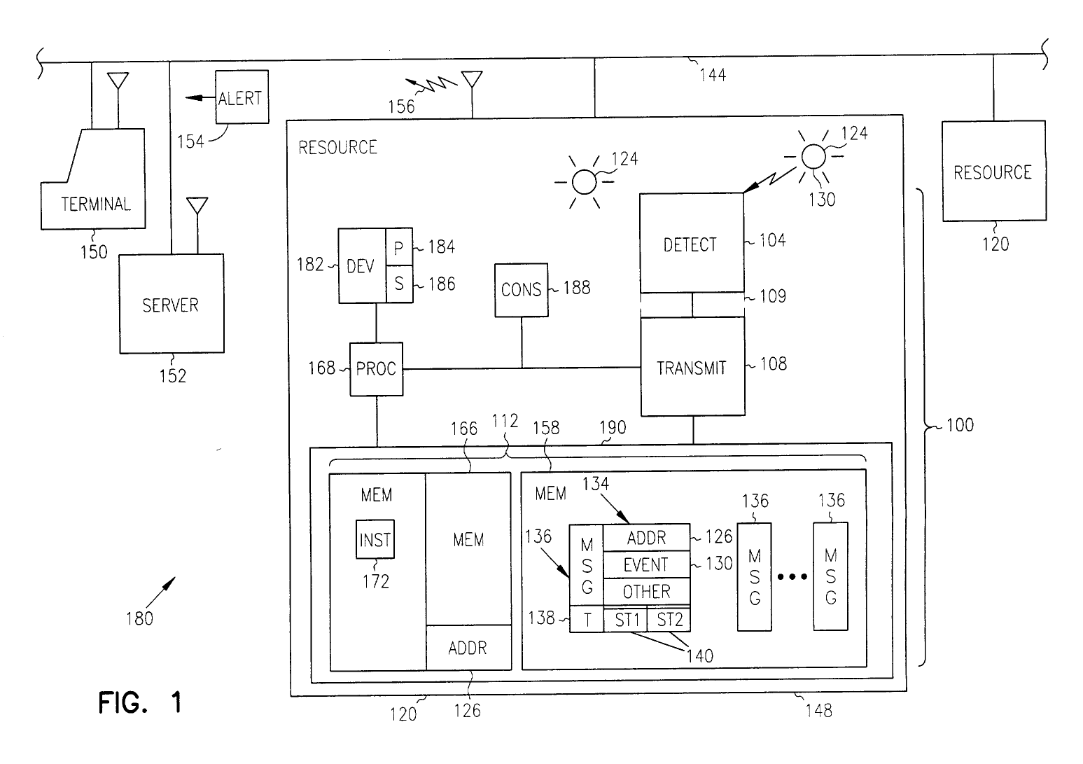

FIG. 1 is a block diagram of an apparatus, an article including a machine-accessible medium, and a system according to various embodiments of the invention. In one embodiment, an alerts notification apparatus 100 includes an event detection module 104, a message transmission module 108 (which may be included in a single device or module 109), and a storage module 112.

In some embodiments of the invention, the event detection module 104 (as well as the entire apparatus 100, for example) is located within a resource 120, and is used to detect a plurality of named events 124 associated with the resource 120. For example, if the resource 120 is a printer, the named events 124 include, but are not limited to: a hardware fault, a software fault, a paper jam, toner cartridge low, toner cartridge empty, stapler low, stapler empty, paper tray low, or paper tray empty. Detecting events 124 associated with a condition of the resource 120 is also possible, such as detecting a consumables condition associated with a paper supply or a toner supply, for example.

Some of the named events 124 will typically be selected for notification, and thus an address 126 can be associated with one or more selected events 124. For example, a supplier may wish to know when a toner supply has reached 20% of capacity so that a new cartridge can be ordered in a timely fashion. In this case, the event “toner low” 124 can be selected for notification to the supplier and associated with a particular address.

The message transmission module 108 can be used to transmit a message 136 to the address 126, which can be the email address of a consumables supplier, for example. Messages 136 can include any number of individual elements, such as the address 126 to which the message is to be transmitted, the time 138 at which the message is transmitted (i.e., the “time stamp”), the selected event 130, and a plurality of status conditions 140 associated with the resource 120. The message 136 can be transmitted by way of a network 144 connecting several resources 120 to one or more message destinations 150 (e.g., message 134 is transmitted to the resource user terminal 150).

The message transmission module 108 may be located internal to the apparatus 100 and/or resource 120, or located externally, for example, as a stand alone computer, including a Simple Mail Transport Protocol (SMTP) Server 152. For more information on SMTP, please refer to Request For Comment (RFC) 821, “Simple Mail Transfer Protocol”, August 1982. The resource 120, such as a printer 120, can be programmed to search for a chosen SMTP Server 152, either by SMTP name or an Internet Protocol (IP) address. When the resource 120 determines it is time to send out one or more email alerts 154 to one or more destinations 150, the resource 120 opens a connection to the chosen server(s) 152, and delivers selected email content (e.g., one or more elements of the message 136), including the intended email addresses 126 destined to receive the messages 136, to the server 152. Then the server 152, on behalf of the resource 120, can actually sends the alert message 154 to the desired destinations, such as a user terminal 150. The content of the alert message 154 may include all or part of the elements of the message 136, and even include additional elements, if desired, and embodiments of the invention are not so limited. If the apparatus 100 does not have access to the time (or even if time stamping is available), the messages 136 may include one or more sequence identification numbers 138 which track one or more counters that count the number of events 124, selected events 130, messages 136, and/or alert messages 154 sent out from the apparatus 100.

The event detection module 104 may be, may include, or may be include in an embedded Java Virtual Machine (JVM) module. For example, the JVM module 104 can receive events 124 from core resource firmware (possibly included as part of the storage module 112) and determine whether an alert 154 should be sent to an address 126. The JVM module 104 can be programmed to send alerts 154 to email addresses of a form similar to or identical to johndoe@somewhere-com (to avoid inadvertent hyperlinks the periods in the preceding address have been replaced by dashes), in which case the JVM module 104 contacts the selected SMTP Server 152. The JVM module 104 can also be programmed to send out alert posts 154, formatted as extensible markup language (XML) to a uniform resource locator (URL) address formatted similarly to, or identically to the address http://15-62-71-66:4240 (to avoid inadvertent hyperlinks the periods in the preceding URL have been replaced by dashes). Thus, the JVM module 104 does not require the assistance of an SMTP server 152 when sending out the alert 154, as a post 154, to a URL address. It should be noted that while SMTP email addresses, XML formatting and URL addresses have been used to describe some aspects of various embodiments of the invention, other embodiments are not so limited, and that many other forms of addressing, formatting, and the like may be used. Alerts 154 can be transmitted using wires 144, and/or a carrier wave (e.g., in a wireless network) 156, including, but not limited to a radio frequency, infrared, or optical carrier wave.

The storage module 112 is used to store messages 136, including the message elements 126, 130, 138, 140. The storage module 112 can include a volatile or nonvolatile memory device 158, such as a first-in, first-out (FIFO) memory device 158. The storage module 112 can also include a disk drive, a tape drive, and/or any other type of storage device 158, including any type of storage medium.

In yet another embodiment, the invention can include means 104 for detecting an event 130 associated with a condition of a resource 148. The means 104 for detecting the event 130 can be located within the resource 148. The invention can also include a means 108 for transmitting a message 134 including the event 130, an address 126 to which the message 134 is transmitted, and a time 138 the message 134 is transmitted to the address 126. The invention can also include a means 112 for storing the message 134. As noted previously, the means 108 for transmitting the message 134 can include wires 144, or a carrier wave 156.

The means 112 for storing the message 134 can comprise one or more individual storage devices. For example, the means 112 for storing the message 134 can include a first memory 166 to store the address 126, and a second memory 158 to store the message 134.

It should also be noted that the apparatus 100 can include one or more of the following components: a processor 168 and storage devices 112, 158, 166, including volatile memories and nonvolatile memories. The storage devices 112, 158, and 166 may comprise a single device 112, or a plurality of devices, and embodiments of the invention are not so limited. One or more of the storage devices 112, 158, 166 can also include program instructions 172.

In yet another embodiment of the invention, a system 180 can include a resource 120 capable of being operatively coupled to a network 144, wireless or wired, and an apparatus 100. The resource 120 can include any number of devices 182, such as an input device (e.g. a scanner) 182, an output device 182, including a printing mechanism (e.g., when the resource is a printer or a fax machine) 184, and/or a storage mechanism (e.g., when the resource is a cartridge tape drive) 186. Typically, although embodiments of the invention are not so limited, the resource 120 uses one or more consumable items 188, such as paper, toner, tape cartridges, film cartridges, etc.

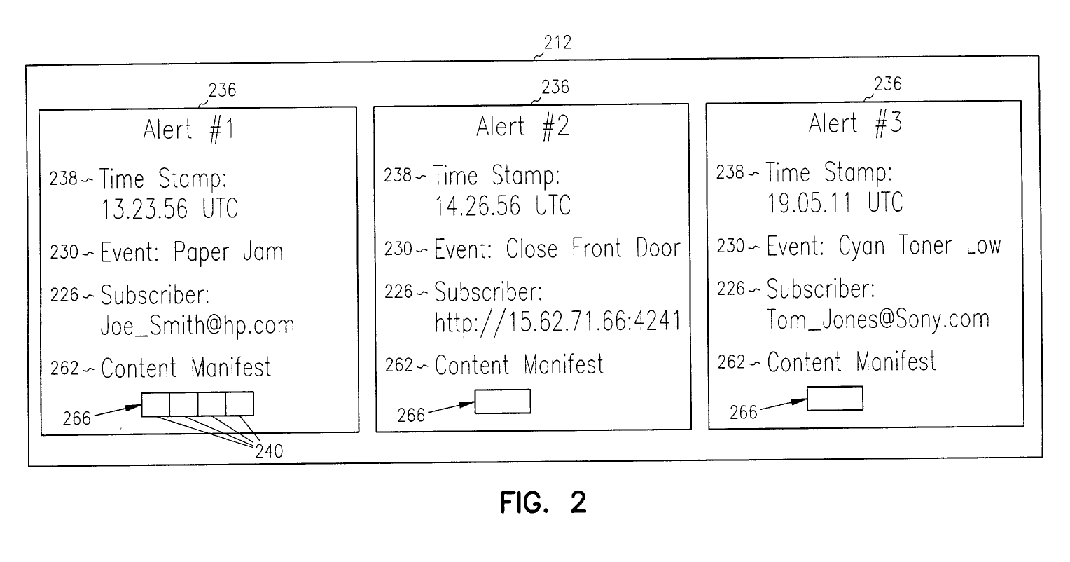

FIG. 2 illustrates a group of messages sent and stored by a printer resource according to an embodiment of the invention. For example, as shown in the figure, several messages 236 can be stored in the storage module 212. The number of messages 236 (e.g., three) stored can be selected by the resource manufacturer, or a resource user. The storage module 212 can be included in the resource, or can be located external to the resource as noted above, and embodiments of the invention are not so limited.

Each message 236 can include any number of elements, as noted previously. For example, each of the messages 236 in FIG. 2 includes a time stamp (i.e., the time the message was transmitted) 238, a selected event 230, a subscriber address 226, and an alert content manifest 262. The address 226 can exist in any number of forms, including one or more destination addresses formatted according to a simple mail transfer protocol or a uniform resource identifier, including but not limited to a URL.

The alert content manifest 262 can include a number of items, such as selected pages 266 of information, including one or more of a supplies alert, a service alert, a media path alert, and/or an advisory alert, as provided by various printers, for example. The alert content manifest 262 can also include a plurality of status conditions 240, such as those noted above.

Referring now to both FIGS. 1 and 2, the apparatus 100, the event detection module or means 104, the message transmission module or means 108, the storage module or means 112, 212, the resources 120, the network 144, the memories 158, 166, the processor 168, the system 180, device 182, printing mechanism 184, and storage mechanism 186 can all be characterized as “modules” herein. Such modules can include hardware, circuitry, and/or a microprocessor and/or memory circuits, software program modules, and/or firmware, and combinations thereof, as desired by the architect of the apparatus 100, resource 120, and system 180, and appropriate for particular embodiments of the invention.

One of ordinary skill in the art will understand that the apparatus and systems of various embodiments of the invention can be used in applications other than for printer resources, and in applications other than for networks which include personal computers, and thus, embodiments of the invention are not so limited. The illustrations of an apparatus 100 and a system 180 are intended to provide a general understanding of the structure of various embodiments of the invention, and they are not intended to serve as a complete description of all the elements and features of apparatus and systems which might make use of the structures described herein.

Applications which can include the novel apparatus and systems of various embodiments of the invention include electronic circuitry used in highspeed computers, communication and signal processing circuitry, modems, processor modules, embedded processors, and application-specific modules, including multilayer, multi-chip modules. Such apparatus and systems can further be included as sub-components within a variety of electronic systems, such as televisions, cellular telephones, fax machines, personal computers, radios, vehicles, and others.

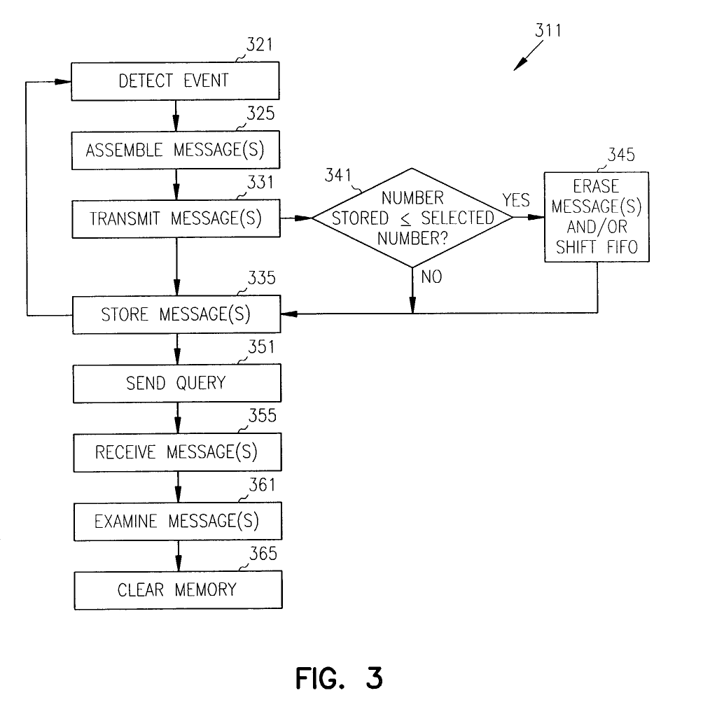

FIG. 3 is a flow diagram illustrating a method according to an embodiment of the invention. The method 311 can begin with detecting a selected event included in a plurality of named events associated with a resource at block 321. If the detected event has been selected for notification, a notification message can be assembled at block 325. As mentioned previously, the message can include an address, the time of transmission, and an alert content manifest having one or more status conditions associated with the resource. If desired, the message can include more than one address, such that multiple parties (i.e. destinations) are notified that the selected event has been detected.

The message is transmitted to the address (or addresses) included in the message at block 331, and each message transmitted is stored at block 335. If desired, the number of messages to be stored can be selected by the manufacturer of the resource and/or a user of the resource or some other entity. In this case, if the number of messages stored is less than the selected number of messages at block 341, then the message is stored at block 335. However, if the number of messages already stored is greater than or equal to the selected number, then one or more of the stored messages can be erased at block 345, and the new message (or messages, if multiple messages have been transmitted) can be stored at block 335. Typically, although embodiments of the invention are not so limited, messages are stored according to a time sequence, such that the older messages are erased, newer messages are moved to older storage locations, and the newest messages are saved in “most recent” locations as occurs with a FIFO. The selected number of messages can be chosen to accommodate or correspond to a production volume output for the resource, an expected query frequency for an administrator of the resource, an expected notification frequency for the resource, the reliability of some element of the resource, and other selected circumstances.

Messages can be stored in a nonvolatile memory included in the resource, or in mass storage external to the resource, although embodiments of the invention are not so limited. If a particular message is sent to more than one address, a list of all of the addresses to which the message is sent, or a subset of all of the addresses, can be included in each one of the messages. A message sent to multiple addresses can be sent to all of the addresses in a substantially simultaneous fashion, such that each message has the same time stamp (i.e., includes the same time). Alternatively, each message can be sent individually, and include the time at which it was sent, along with the times other messages were sent, if the information is available.

The method continues by detecting a new event at block 321, and/or by sending a query to the resource requesting one or more of the stored messages at block 351. In some embodiments of the invention, for example, this can occur when a system administrator checks the functionality of the resource by requesting the queue of stored messages in order to review the resource event history. The query for one or more messages can be made via network inquiries. Alternatively, or in addition, queries can be made at an interface coupled to the resource, such as a keyboard and display attached to a printer, or at a remote terminal coupled to the resource via a network.

Receiving the requested message occurs at block 355. The method continues with examining the message(s) at block 361. Thus, for example, in some embodiments of the invention, a resource user might walk up to the resource (e.g., a printer) and view the queue of messages stored therein. The method concludes at block 365 with clearing the memory where messages are stored, and/or continues with detecting new events at block 321.

Thus, referring back to FIG. 1, it is now easily understood that another embodiment of the invention can include an article 190, such as a computer, a memory system, a magnetic or optical disk, some other storage device, and/or any type of electronic device or system, comprising a machine-accessible medium 112 (e.g., a memory including an electrical, optical, or electromagnetic conductor) having associated data 172 (e.g. computer program instructions), which when accessed, results in a machine performing such actions as storing an address associated with a selected event in a nonvolatile memory included in a resource (wherein the selected event is associated with a condition of the resource), detecting the selected event, transmitting a message to the address at a recorded time (wherein the message includes the address, the selected event, and the time), and storing the message in the nonvolatile memory. Other actions include, but are not limited to clearing the nonvolatile memory, for example.

Although specific embodiments have been illustrated and described herein, those of ordinary skill in the art will appreciate that any arrangement calculated to achieve the same purpose can be substituted for the embodiments shown. This disclosure is intended to cover any and all adaptations or variations of various embodiments of the invention. It is to be understood that the above description has been made in an illustrative fashion, and not a restrictive one. Combinations of the above embodiments, and other embodiments not specifically described herein will be apparent to those of skill in the art upon reviewing the above description. The scope of various embodiments of the invention includes any other applications in which the above structures and methods are used. Therefore, the scope of various embodiments of the invention should be determined with reference to the appended claims, along with the full range of equivalents to which such claims are entitled.

It is emphasized that the Abstract is provided to comply with 37 C.F.R. §1.72(b) requiring an Abstract that will allow the reader to quickly ascertain the nature of the technical disclosure. It is submitted with the understanding that it will not be used to interpret or limit the scope or meaning of the claims.

In the foregoing detailed description, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the detailed description, with each claim standing on its own as a separate preferred embodiment.

What is claimed is:

1. An apparatus, comprising:
an event detection module for location within a resource to detect a plurality of named events associated with the resource including a selected event;
a message transmission module to transmit a message to an address, wherein the message includes the address, the selected event, and a plurality of status conditions associated with the resource; and
a storage module to store the message.

2. The apparatus of claim 1, wherein the storage module comprises a first-in, first-out (FIFO) memory device.

3. The apparatus of claim 2, wherein the storage module comprises a nonvolatile memory device.

4. The apparatus of claim 1, wherein the message includes a time at which the message is sent to the address.

5. The apparatus of claim 1, wherein the plurality of status conditions comprises an alert content manifest.

6. A system, comprising:
a resource capable of being coupled to a network; and an apparatus operatively coupled to the resource, the apparatus including an event detection module for location within the resource to detect a plurality of named events associated with the resource including a selected event, a message transmission module to transmit a message to an address, wherein the message includes the address, the selected event, and a plurality of status conditions associated with the resource, and a storage module to store the message.

7. The system of claim 6, wherein the address includes at least one destination address formatted according to a simple mail transfer protocol or a uniform resource identifier.

8. The system of claim 6, wherein the resource comprises an input device.

9. The system of claim 6, wherein the resource comprises an output device.

10. The system of claim 9, wherein the output device comprises a printing mechanism.

11. The system of claim 10, wherein the selected event includes at least one indication of a hardware fault, a software fault, a paper jam, a toner cartridge low, a toner cartridge out, a stapler low, a stapler out, a paper tray low, or a paper tray empty.

12. A method, comprising:
detecting a selected event included in a plurality of named events associated with a resource;
transmitting a first message to a first address at a first time, wherein the message includes the first address, the selected event, the first time, and a plurality of status conditions associated with the resource; and
storing the first message in a nonvolatile memory included in the resource.

13. The method of claim 12, further comprising:
examining the first message stored in the nonvolatile memory.

14. The method of claim 13, further comprising:
sending a query to the resource requesting the first message stored in the nonvolatile memory; and
receiving the first message stored in the nonvolatile memory.

15. The method of claim 12, further comprising:
storing a selected number of messages in the nonvolatile memory.

16. The method of claim 12, wherein the first message includes a second address, further comprising:
transmitting a second message to the second address at a second time, wherein the second message includes the first address, the second address, the selected event, the second time, and the plurality of status conditions associated with the resource; and
storing the second message in the nonvolatile memory included in the resource.

17. An article comprising a machine-accessible medium having associated data, wherein the data, when accessed, results in a machine performing:
storing an address associated with a selected event in a nonvolatile memory included in a resource, wherein the selected event is associated with a condition of the resource;
detecting the selected event;
transmitting a message to the address at a time, wherein the message includes the address, the selected event, and the time; and
storing the message in the nonvolatile memory.

18. The article of claim 17, wherein the machine-accessible medium further includes data, which when accessed by the machine, results in the machine performing:
clearing the nonvolatile memory.

19. The article of claim 17, wherein the message includes an alert content manifest having at least one of a supplies alert, a service alert, a media path alert, or an advisory alert.

20. The article of claim 19, wherein the message is stored in the nonvolatile memory according to a time sequence.

21. An apparatus, comprising:
means for detecting an event associated with a condition of a resource, wherein the means for detecting an event is located within the resource;
means for transmitting a message including the event, the address, and a time the message is transmitted to the address at the time; and
means for storing the message.

22. The apparatus of claim 21, wherein the means for transmitting the message includes a carrier wave.

23. The apparatus of claim 21, wherein the condition of the resource includes a consumables condition associated with a paper supply.

24. The apparatus of claim 21, wherein the condition of the resource includes a consumables condition associated with a toner supply.

25. The apparatus of claim 21, wherein the means for storing comprises a first memory to store the address, and a second memory to store the message.
